(19) United States
(12) Patent Application Publication
(10) Pub. No.: US 2023/0416505 A1
(43) Pub. Date: Dec. 28, 2023

(54) RUBBER RESIN MATERIAL AND METAL SUBSTRATE

(71) Applicant: NAN YA PLASTICS CORPORATION, Taipei (TW)

(72) Inventors: TE-CHAO LIAO, TAIPEI (TW); HUNG-YI CHANG, TAIPEI (TW)

(21) Appl. No.: 17/990,729

(22) Filed: Nov. 20, 2022

(30) Foreign Application Priority Data
Jun. 24, 2022 (TW) 111123563

(51) Int. Cl. C08L 9/00; C08K 9/04; C08K 3/36; C08K 5/101; B32B 15/08; B32B 25/00; B32B 27/00

(52) U.S. Cl. CPC C08L 9/00; C08K 9/04; C08K 3/36; C08K 5/101; B32B 15/08; B32B 25/00; B32B 27/00; B32B 15/14

(57) ABSTRACT

A rubber resin material and a metal substrate are provided. The rubber resin material includes a resin composition and inorganic fillers. The inorganic fillers are uniformly dispersed in the resin composition. The resin composition includes: 10 wt % to 50 wt % of a liquid rubber, 20 wt % to 60 wt % of a polyphenylene ether resin, and 5 wt % to 60 wt % of a cyanate resin. The polyphenylene ether resin includes a polyphenylene ether that has a bismaleimide group at molecular ends thereof, a polyphenylene ether that has a methacrylate group at molecular ends thereof, a polyphenylene ether that has a styrene group at molecular ends thereof, or a combination thereof. The cyanate resin includes a bisphenol M type cyanate resin.

### CROSS-REFERENCE TO RELATED PATENT APPLICATION

This application claims the benefit of priority to Taiwan Patent Application No. 111123563, filed on Jun. 24, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a rubber resin material and a metal substrate, and more particularly to a low-dielectric rubber resin material and a metal substrate.

### BACKGROUND OF THE DISCLOSURE

With the advancement of the fifth generation wireless system (5G wireless system), high frequency transmission has undoubtedly become the main development trend in an attempt to meet requirements of the 5G wireless system. In the existing high frequency transmission technology (i.e., a frequency ranging from 28 GHz to 60 GHz), how to reduce signal loss on a transmission path is an important objective to be achieved.

In order to reduce the signal loss, an antenna-in-package (AIP) technology that integrates an antenna and a radio frequency front-end (RFFE) circuit into a transceiver module has been developed. Accordingly, a distance between the antenna and an amplifier (or other circuit systems) can be shortened, such that the signal loss on the transmission path and a product volume can be reduced.

In the antenna-in-package (AIP) technology, relevant industries have strived to develop a rubber resin material that is applicable for high frequency transmission. For high frequency transmission, the rubber resin material usually needs to have a low dielectric constant (Dk) and a low dielectric dissipation factor (Df). In this specification, the dielectric constant and the dielectric dissipation factor are collectively referred to as dielectric properties of the rubber resin material.

A rubber resin material currently on the market contains a certain amount of liquid rubber, so as to decrease the dielectric properties. However, the liquid rubber cannot be added without limit. When an amount of the liquid rubber is too high, a glass transition temperature (Tg) of the rubber resin material decreases. Further, a peeling strength between the rubber resin material and a metal layer can also be decreased.

Therefore, how to adjust components of the rubber resin material for purposes of achieving a good thermal resistance, a strong peeling strength, and good dielectric properties has become an important issue in the related art.

### SUMMARY OF THE DISCLOSURE

In response to the above-referenced technical inadequacies, the present disclosure provides a rubber resin material and a metal substrate.

In one aspect, the present disclosure provides a rubber resin material. The rubber resin material includes a resin composition and inorganic fillers. The inorganic fillers are uniformly dispersed in the resin composition. The resin composition includes: 10 wt % to 50 wt % of a liquid rubber, 20 wt % to 60 wt % of a polyphenylene ether resin, and 5 wt % to 60 wt % of a cyanate resin. The polyphenylene ether resin includes a polyphenylene ether that has a bismaleimide group at molecular ends thereof, a polyphenylene ether that has a methacrylate group at molecular ends thereof, a polyphenylene ether that has a styrene group at molecular ends thereof, or a combination thereof. The cyanate resin includes a bisphenol M type cyanate resin.

In certain embodiments, a bismaleimide resin is absent from the resin composition.

In certain embodiments, a molecular weight of the cyanate resin ranges from 100 g/mol to 3,000 g/mol.

In certain embodiments, a number average molecular weight of the polyphenylene ether resin ranges from 1,500 g/mol to 5,000 g/mol.

In certain embodiments, a hydroxyl value of the polyphenylene ether resin is lower than 0.5 mg KOH/g.

In certain embodiments, a molecular weight of the liquid rubber ranges from 3,500 g/mol to 4,200 g/mol.

In certain embodiments, the liquid rubber is synthesized from a butadiene monomer. Based on a total amount of the liquid rubber being 100 wt %, the liquid rubber contains 60 wt % to 80 wt % of a vinyl group.

In certain embodiments, the liquid rubber is a butadiene homopolymer.

In certain embodiments, a viscosity of the liquid rubber measured at 25° C. ranges from 35,000 cps to 43,000 cps.

In certain embodiments, based on a total weight of the resin composition being 100 phr, an amount of the inorganic fillers ranges from 50 phr to 180 phr.

In certain embodiments, the inorganic fillers undergo a surface modification process to have at least one of a methacrylate group and a vinyl group.

In certain embodiments, the rubber resin material includes a peroxide. Based on a total weight of the resin composition being 100 phr, an amount of the peroxide ranges from 0.5 phr to 5 phr.

In another aspect, the present disclosure provides a metal substrate. The metal substrate includes a substrate layer and a metal layer disposed on the substrate layer. The substrate layer is formed from a rubber resin material. The rubber resin material includes a resin composition and inorganic fillers. The inorganic fillers are uniformly dispersed in the resin composition. The resin composition includes 10 wt % to 50 wt % of a liquid rubber, 20 wt % to 60 wt % of a polyphenylene ether resin, and 5 wt % to 60 wt % of a cyanate resin. The polyphenylene ether resin includes a polyphenylene ether that has a bismaleimide group at molecular ends thereof, a polyphenylene ether that has a methacrylate group at molecular ends thereof, a polyphenylene ether that has a styrene group at molecular ends thereof, or a combination thereof. The cyanate resin includes a bisphenol M type cyanate resin.

In certain embodiments, a dielectric dissipation factor of the rubber resin material measured at 10 GHz is lower than 0.0035.

In certain embodiments, a dielectric constant of the rubber resin material measured at 10 GHz ranges from 3.0 to 3.5.

In certain embodiments, a glass transition temperature of the rubber resin material ranges from 210° C. to 270° C.

In certain embodiments, a peeling strength of the metal substrate ranges from 4.0 lb/in to 7.5 lb/in.

In certain embodiments, a coefficient of thermal expansion of the metal substrate ranges from 20 ppm/° C.·K to 40 ppm/° C.·K.

Therefore, in the rubber resin material and the metal substrate provided by the present disclosure, by virtue of “the resin composition including a liquid rubber, a polyphenylene ether resin, and a cyanate resin” and “the cyanate resin including a bisphenol M type cyanate resin,” the rubber resin material can have good dielectric properties and a high glass transition temperature, and the metal substrate can have a good thermal resistance, a strong peeling strength, and a low coefficient of thermal expansion.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Rubber Resin Material

In the present disclosure, by using a specific polyphenylene ether resin, the problem of a rubber resin material having a poor thermal resistance and a weak peeling strength due to addition of an excessive amount of a liquid rubber can be solved. In addition, after adding the polyphenylene ether resin, the rubber resin material does not have poor dielectric properties (i.e., a high dielectric constant and a high dielectric dissipation factor). Moreover, by using a specific cyanate resin, a coefficient of thermal expansion (CTE) of the rubber resin material can be decreased in the present disclosure. Accordingly, the rubber resin material of the present disclosure can have a good thermal resistance, a strong peeling strength, good dielectric properties, and a low coefficient of thermal expansion.

Specifically, the rubber resin material of the present disclosure includes a resin composition and inorganic fillers. The inorganic fillers are uniformly dispersed in the resin composition. Detailed descriptions on properties of the resin composition and the inorganic fillers are provided below.

### Resin Composition

The resin composition of the present disclosure includes: 10 wt % to 50 wt % of the liquid rubber, 20 wt % to 60 wt % of the polyphenylene ether resin, and 5 wt % to 60 wt % of the cyanate resin.

Through the resin composition with the aforesaid components and contents, the rubber resin material of the present disclosure can be used to manufacture a metal substrate that has a good thermal resistance, good dielectric properties, and a low coefficient of thermal expansion, and said metal substrate is applicable for high frequency transmission. In addition, the rubber resin material of the present disclosure can have a strong adhesive force with a metal layer. Specific property tests for the rubber resin material and the metal substrate will be illustrated below.

The rubber resin material of the present disclosure contains the liquid rubber. The liquid rubber has a high solubility, so that compatibility of the components in the rubber resin material can be enhanced. In addition, the liquid rubber has reactive functional groups, which can enhance a crosslinking degree of the rubber resin material after solidification.

The liquid rubber of the present disclosure has a molecular weight ranging from 2000 g/mol to 6000 g/mol, such that flowability of the resin composition can be enhanced. Accordingly, a glue filling property of the rubber resin material can also be optimized. Preferably, the molecular weight of the liquid rubber ranges from 3500 g/mol to 4200 g/mol. For example, the molecular weight of the liquid rubber can be 3600 g/mol, 3700 g/mol, 3800 g/mol, 3900 g/mol, 4000 g/mol, or 4100 g/mol. A viscosity of the liquid rubber measured at 25° C. ranges from 35,000 cps to 43,000 cps.

Preferably, the resin composition contains 15 wt % to 45 wt % of the liquid rubber. For example, an amount of the liquid rubber in the resin composition can be 20 wt %, 25 wt %, 30 wt %, 35 wt %, or 40 wt %.

In an exemplary embodiment, the liquid rubber includes a liquid diene rubber. Preferably, the liquid diene rubber has a high ratio of a vinyl group-containing side chain. In particular, the liquid diene rubber has a high ratio of a 1,2-vinyl group-containing side chain.

When the liquid rubber has at least one unsaturated side chain that contains a vinyl group (or a vinyl side chain), a crosslink density and the thermal resistance of the rubber resin material after solidification can both be enhanced. Specifically, the liquid rubber is synthesized from a butadiene monomer. The liquid rubber can be synthesized merely from the butadiene monomer, or can be synthesized from the butadiene monomer and other monomers. In other words, the liquid rubber can be a butadiene homopolymer or a butadiene copolymer. Preferably, the liquid rubber is the butadiene homopolymer.

When the liquid rubber is synthesized from the butadiene monomer, based on a total weight of the liquid rubber being 100 wt %, the liquid rubber can contain 60 wt % to 80 wt % of the vinyl group.

In an exemplary embodiment, the liquid rubber is the butadiene homopolymer. In other words, the liquid rubber is synthesized merely from the butadiene monomer, exclusive of other monomers (such as a styrene monomer).

Preferably, the resin composition contains 25 wt % to 55 wt % of the polyphenylene ether resin. For example, an amount of the polyphenylene ether resin in the resin composition can be 30 wt %, 35 wt %, 40 wt %, 45 wt %, or 50 wt %.

Addition of the polyphenylene ether resin allows the rubber resin material to have good dielectric properties, a high glass transition temperature, and a low coefficient of thermal expansion.

In an exemplary embodiment, a number average molecular weight of the polyphenylene ether resin ranges from 1,500 g/mol to 5,000 g/mol. Preferably, the number average molecular weight of the polyphenylene ether resin ranges from 1,500 g/mol to 4,500 g/mol. More preferably, the number average molecular weight of the polyphenylene ether resin ranges from 1,500 g/mol to 3,500 g/mol.

The polyphenylene ether resin of the present disclosure includes a first polyphenylene ether, a second polyphenylene ether, a third polyphenylene ether, or any combination thereof. The first polyphenylene ether has a bismaleimide group at two molecular ends thereof. The second polyphenylene ether has a methacrylate group at two molecular ends thereof. The third polyphenylene ether has a styrene group at two molecular ends thereof.

In an exemplary embodiment, an average number of the bismaleimide group in the first polyphenylene ether ranges from 1 to 2, and the first polyphenylene ether has a hydroxyl value lower than 0.5 mg KOH/g. The bismaleimide group of the first polyphenylene ether can provide an unsaturated bond to facilitate a crosslinking reaction, thereby enhancing a peeling strength of the rubber resin material. Therefore, due to addition of the first polyphenylene ether, the rubber resin material can have good dielectric properties, a high glass transition temperature, a strong peeling strength, and a low coefficient of thermal expansion.

Moreover, after the first polyphenylene ether is added, addition of the liquid rubber can be slightly reduced. For example, when the resin composition includes 20 wt % to 40 wt % of the first polyphenylene ether, the amount of the liquid rubber can be decreased to range from 10 wt % to 30 wt %, so as to prevent the glass transition temperature of the rubber resin material from decreasing or the peeling strength of the rubber resin material from weakening.

It is worth mentioning that the first polyphenylene ether of the present disclosure can replace a bismaleimide resin in a conventional rubber resin material. In other words, the bismaleimide resin can be absent from the rubber resin material of the present disclosure. As a result, the rubber resin material of the present disclosure has fewer components, such that the compatibility of the rubber resin material can be enhanced, and the amount of the liquid rubber added in the rubber resin material can be decreased.

Addition of the second polyphenylene ether and the third polyphenylene ether of the present disclosure can enhance the dielectric properties of the rubber resin material, especially for decreasing the dielectric dissipation factor. Therefore, the first polyphenylene ether, the second polyphenylene ether, and the third polyphenylene ether can also be mixed for improving properties of the rubber resin material.

The cyanate resin of the present disclosure has a cyanate group at molecular ends thereof. Addition of the cyanate resin enhances a crosslink extent between the liquid rubber and the polyphenylene ether resin. In addition, the addition of the cyanate resin can reduce the coefficient of thermal expansion of the rubber resin material and further enhance a thermal stability of the metal substrate.

Preferably, an amount of the cyanate resin in the resin composition can range from 10 wt % to 55 wt %. For example, the amount of the cyanate resin in the resin composition can be 15 wt %, 20 wt %, 25 wt %, 30 wt %, 35 wt %, 40 wt %, 45 wt %, or 50 wt %.

In the present disclosure, the cyanate resin includes a cyanate resin that has a main structure formed from bisphenol M. In other words, the cyanate resin includes a bisphenol M type cyanate resin.

The cyanate resin has cyanate groups at the molecular ends of the main structure, and an average number of the cyanate groups of the cyanate resin ranges from 1 to 2. In some embodiments, a weight average molecular weight of the cyanate resin ranges from 100 g/mol to 70,000 g/mol. Preferably, the weight average molecular weight of the cyanate resin ranges from 100 g/mol to 5,000 g/mol. More preferably, the weight average molecular weight of the cyanate resin ranges from 100 g/mol to 1,000 g/mol. A viscosity of the cyanate resin measured at 25° C. ranges from 425 mPa·s to 475 mPa·s. When the weight average molecular weight and the viscosity of the cyanate resin are within the aforementioned ranges, the crosslink extent of the resin composition can be enhanced. Moreover, the viscosity and processability of the resin composition will not be negatively influenced, which is beneficial for further application of the resin composition.

In an exemplary embodiment, the cyanate resin can further include one or more cyanate compounds. The cyanate compounds contain two or more cyanate groups.

### Inorganic Fillers

Addition of the inorganic fillers can help decrease the viscosity and the dielectric constant of the rubber resin material. Certain kinds of the inorganic fillers can also enhance thermal conductivity of the rubber resin material. The description above is for illustrative purposes only, and the present disclosure is not limited thereto.

In the present disclosure, the inorganic fillers include silicon dioxide, strontium titanate, calcium titanate, titanium dioxide, alumina, or any combination thereof. However, the present disclosure is not limited thereto. In an exemplary embodiment, the inorganic fillers include silicon dioxide, alumina, and titanium dioxide at the same time. In addition, the silicon dioxide can be replaced with strontium titanate, calcium titanate, or a combination thereof. The silicon dioxide can be fused silica or crystalline silica. Preferably, the silicon dioxide is fused silica.

In an exemplary embodiment, the inorganic fillers undergo a surface modification process to have at least one of a methacrylate group and a vinyl group. Therefore, the inorganic fillers can react with the liquid rubber, such that the resin composition can have good compatibility with the inorganic fillers and the thermal resistance of the metal substrate is not negatively influenced.

It should be noted that the inorganic fillers can include only one component or include various components. In addition, the inorganic fillers can all undergo the surface modification process, or only a part of the inorganic fillers undergo the surface modification process, so as to have at least one of the methacrylate group and the vinyl group. For example, in one embodiment, when the inorganic fillers include silicon dioxide and alumina, the silicon dioxide is surface modified to have at least one of the methacrylate group and the vinyl group, but the alumina is not surface modified. However, the present disclosure is not limited thereto.

An appearance of the inorganic fillers can be spherical. An average particle size (D₅₀) of the inorganic fillers ranges from 0.3 μm to 3 μm. The particle size (D₉₉) of the inorganic fillers is lower than 10 μm, such that the inorganic fillers can be uniformly dispersed in the resin composition. In an exemplary embodiment, a purity of the inorganic fillers is higher than or equal to 99.8%.

An amount of the inorganic fillers can be adjusted according to product requirements. In an exemplary embodiment, based on the total weight of the resin composition being 100 phr, the amount of the inorganic fillers ranges from 50 phr to 180 phr. Preferably, the amount of the inorganic fillers ranges from 60 phr to 160 phr. More preferably, the amount of the inorganic fillers ranges from 70 phr to 150 phr. However, the present disclosure is not limited thereto.

### Siloxane Coupling Agent

The rubber resin material can further include a siloxane coupling agent. Due to addition of the siloxane coupling agent, reactivity and compatibility between a fiber cloth, the resin composition, and the inorganic fillers can be enhanced, thereby increasing the peeling strength and thermal resistance of the metal substrate.

In an exemplary embodiment, the siloxane coupling agent has at least one of a methacrylate group and a vinyl group. A molecular weight of the siloxane coupling agent ranges from 100 g/mol to 500 g/mol. Preferably, the molecular weight of the siloxane coupling agent ranges from 110 g/mol to 250 g/mol. More preferably, the molecular weight of the siloxane coupling agent ranges from 120 g/mol to 200 g/mol.

Based on the total weight of the resin composition being 100 phr, an amount of the siloxane coupling agent ranges from 0.1 phr to 5 phr. Preferably, the amount of the siloxane coupling agent ranges from 0.5 phr to 3 phr.

### Peroxide

The rubber resin material can further include a peroxide, which can be used as an initiator of free radicals. Preferably, the peroxide can be an olefin-based crosslinking initiator. Based on the total weight of the resin composition being 100 phr, an amount of the peroxide ranges from 0.5 phr to 5 phr. For example, the peroxide can be a tert-butylcumyl peroxide, a dicumyl peroxide (DCP), a benzoyl peroxide (BPO), 2,5-dimethyl-2,5-di(tert-butylperoxy)hexane, 2,5-dimethyl-2,5-di(tert-butylperoxy)hexyne, 1, 1-di-(tert-butylperoxy)-3, 3, 5-trimethylcyclohexane, bis(tert-butylperoxyisopropyl)benzene, or a combination thereof.

### Catalyst

The rubber resin material can further include a catalyst. The catalyst facilitates the rubber resin material to solidify and form into a high frequency substrate. Based on the total weight of the resin composition being 100 phr, an amount of the catalyst ranges from 0.25 phr to 1.5 phr.

For example, the catalyst can be imidazole compounds, such as triphenylimidazole, 2-ethyl-4-methylimidazole (2E4MZ), 1-benzyl-2-phenylimidazole (1B2PZ), 1-cyanoethyl-2-phenylimidazole (2PZ-CN), or 2,3-dihydro-1H-pyrrole[1,2-a]benzimidazole (TBZ). However, the present disclosure is not limited thereto.

### Flame Retardant

The resin composition can further include a flame retardant. Addition of the flame retardant can enhance a flame resistant property of the high frequency substrate. For example, the flame retardant can be a phosphorus flame retardant or a brominated flame retardant. Preferably, the flame retardant is a halogen-free flame retardant. That is, the flame retardant does not contain halogen.

The brominated flame retardant can be ethylene bistetrabromophthalimide, tetradecabromodiphenoxy benzene, decabromo diphenoxy oxide, or any combination thereof, but is not limited thereto.

The phosphorus flame retardant can be sulphosuccinic acid ester, phosphazene, ammonium polyphosphate, melamine polyphosphate, melamine cyanurate, or any combination thereof. The sulphosuccinic acid ester includes triphenyl phosphate (TPP), tetraphenyl resorcinol bis(diphenylphosphate) (RDP), bisphenol A bis(diphenyl phosphate) (BPAPP), bisphenol A bis(dimethyl) phosphate (BBC), resorcinol diphosphate (e.g., the model CR-733S produced by DAIHACHI), or resorcinol-bis(di-2,6-dimethylphenyl phosphate) (e.g., the model PX-200 produced by DAIHACHI). However, the present disclosure is not limited thereto.

An amount of the flame retardant can be adjusted according to product requirements. In certain embodiments, relative to 100 phr of the rubber resin composition, the amount of the flame retardant ranges from 0.1 phr to 5 phr.

### Property Tests

In order to prove that the rubber resin material of the present disclosure can be used as a high frequency substrate material, 10 wt % to 50 wt % of the liquid rubber, 20 wt % to 60 wt % of the polyphenylene ether resin, and 5 wt % to 60 wt % of the cyanate resin are mixed to form the resin composition. In addition, the inorganic fillers are further added into the resin composition to form the rubber resin material of Examples 1 to 3 and Comparative Examples 1 to 6. Specific contents of the rubber resin material of Examples 1 to 3 and Comparative Examples 1 to 6 are listed in Table 1. The glass transition temperature, the dielectric constant, and the dielectric dissipation factor of the rubber resin material in each of Examples 1 to 3 and Comparative Examples 1 to 6 are listed in Table 2.

Subsequently, a fiber cloth is immersed into the rubber resin material in each of Examples 1 to 3 and Comparative Examples 1 to 6. After immersion, drying, and molding, a prepreg is obtained. After the prepreg is processed, a metal layer is disposed on the prepreg, so as to form the metal substrate in each of Examples 1 to 3 and Comparative Examples 1 to 6. The peeling strength, the thermal resistance, and the coefficient of thermal expansion of the metal substrate in each of Examples 1 to 3 and Comparative Examples 1 to 6 are listed in Table 2.

In Table 1, the bisphenol M type cyanate resin is 4,4′-[1,3-phenylbis(1-methyl-ethylene)]bisphenylcyanate, and the peroxide is bis(tert-butylisopropylperoxide)benzene. However, the present disclosure is not limited thereto.

In Table 2, the properties of the rubber resin material/the metal substrate are measured by methods below.
(1) Glass transition temperature: measuring the glass transition temperature of the rubber resin material by a thermogravimetric analyzer (TGA);
(2) Dielectric constant (10 GHz): detecting the dielectric constant of the rubber resin material at 10 GHz by a dielectric analyzer (model: HP Agilent E5071C);
(3) Dielectric dissipation factor (10 GHz): detecting the dielectric dissipation factor of the rubber resin material at 10 GHz by the dielectric analyzer (model: HP Agilent E5071C);
(4) Peeling strength: measuring the peeling strength of the metal substrate according to the IPC-TM-650-2.4.8 test method;
(5) Thermal resistance: heating the metal substrate in an autoclave at a temperature of 120° C. and a pressure of 2 atm for 120 minutes, and then putting said metal substrate into a soldering furnace of 288° C., so as to calculate a duration for a delamination process. If the duration for the delamination process is longer than 10 minutes, the term “OK” is shown in Table 1. If the duration for the delamination process is shorter than 10 minutes, the term “NG” is shown in Table 1.
(6) Coefficient of thermal expansion: cutting the metal substrate into a sample that has a size of 4.5 mm×30 mm×0.1 mm, placing the sample in a thermomechanical analyzer (manufactured by TA Instruments), and heating the sample from 40° C. to 340° C. at a temperature-rising rate of 10° C./min, so as to measure a linear coefficient of thermal expansion of the sample (along a planar direction) from 50° C. to 120° C.

TABLE 1

| | | Example | | | Comparative Example | | | | | |
|---|---|---|---|---|---|---|---|---|---|---|
| (phr) | | 1 | 2 | 3 | 1 | 2 | 3 | 4 | 5 | 6 |
| Liquid | Butadiene homopolymer | 8 | 16 | 16 | — | — | — | — | — | — |
| rubber | Butadiene/styrene copolymer | — | — | — | 16 | 8 | 8 | — | — | — |
| | Butadiene/styrene/divinyl terpolymer | — | — | — | — | — | — | 16 | 16 | 16 |
| First polyphenylene ether (having a | | 12 | — | — | 20 | — | — | 20 | — | — |
| bismaleimide group at molecular ends thereof) | | | | | | | | | | |
| Second polyphenylene ether (having a | | — | 20 | — | — | 12 | — | — | 20 | 1 |
| methacrylate group at molecular ends thereof) | | | | | | | | | | |
| Third polyphenylene ether (having a styrene | | — | — | 20 | — | — | 12 | — | — | 20 |
| group at molecular ends thereof) | | | | | | | | | | |
| Cyanate | Bisphenol M type cyanate resin | 20 | 4 | 4 | — | — | — | — | — | — |
| resin | Bisphenol A type cyanate resin | — | — | — | 4 | 20 | 20 | 4 | 4 | 4 |

| | | | | | | | | | |
|---|---|---|---|---|---|---|---|---|---|
| Inorganic fillers (silicon dioxide) | 60 | 60 | 60 | 60 | 60 | 60 | 60 | 60 | 60 |
| Peroxide | 0.4 | 0.4 | 0.4 | 0.4 | 0.4 | 0.4 | 0.4 | 0.4 | 0.4 |

TABLE 2

| | Example | | | Comparative Example | | | | | |
|---|---|---|---|---|---|---|---|---|---|
| | 1 | 2 | 3 | 1 | 2 | 3 | 4 | 5 | 6 |
| Glass transition | 260 | 220 | 220 | 250 | 200 | 175 | 210 | 192 | 185 |
| temperature (° C.) | | | | | | | | | |
| Dielectric constant | 3.45 | 3.35 | 3.35 | 3.43 | 3.52 | 3.44 | 3.5 | 3.42 | 3.45 |
| (10 GHz) | | | | | | | | | |
| Dielectric dissipation | 3.2 | 2.5 | 2.5 | 4.0 | 3.8 | 3.8 | 4.3 | 4.1 | 4.1 |
| factor (10 GHz) × 10³ | | | | | | | | | |
| Peeling strength (lb/in) | 7 | 5 | 4 | 3 | 4 | 4 | 3.5 | 2.8 | 2.5 |
| Coefficient of thermal | 25 | 35 | 37 | 45 | 50 | 55 | 44 | 43 | 50 |
| expansion (ppm/° C. · K) | | | | | | | | | |
| Thermal resistance | OK | OK | OK | OK | OK | OK | OK | OK | OK |

According to the results in Table 1, the rubber resin material in Examples 1 to 3 has a high transition temperature and good dielectric properties, thereby enhancing the thermal resistance of the metal substrate. In addition, the metal substrate in Examples 1 to 3 has a strong peeling strength and a low coefficient of thermal expansion.

A comparison is further made between the rubber resin materials in Examples 1 to 3. When a polyphenylene ether having a bismaleimide group at molecular ends thereof is added into the rubber resin material, the glass transition temperature of the rubber resin material can be increased, thereby enhancing the thermal resistance of the metal substrate. Moreover, the metal substrate can have a strong peeling strength and a low coefficient of thermal expansion. Specifically, the glass transition temperature of the rubber resin material can range from 250° C. to 270° C., the peeling strength of the metal substrate can range from 5.5 lb/in to 7.5 lb/in, and the coefficient of thermal expansion of the metal substrate can range from 20 ppm/° C.·K to 30 ppm/° C.·K.

On the other hand, when a polyphenylene ether having a methacrylate group at molecular ends thereof or a polyphenylene ether having a styrene group at molecular ends thereof is added into the rubber resin material, the dielectric dissipation factor of the rubber resin material can be decreased. Specifically, the dielectric dissipation factor of the rubber resin material is lower than 0.0030.

Therefore, according to different requirements, the polyphenylene ethers that have different functional groups at the molecular ends thereof can be added into the rubber resin material, so as to enable the rubber resin material to possess various properties.

### BENEFICIAL EFFECTS OF THE EMBODIMENTS

In conclusion, in the rubber resin material and the metal substrate provided by the present disclosure, by virtue of “10 wt % to 50 wt % of a liquid rubber, 20 wt % to 60 wt % of a polyphenylene ether resin, and 5 wt % to 60 wt % of a cyanate resin,” the rubber resin material can have good dielectric properties and a high glass transition temperature, and the metal substrate can have a good thermal resistance, a strong peeling strength, and a low coefficient of thermal expansion.

Further, in the rubber resin material and the metal substrate provided by the present disclosure, by virtue of “the polyphenylene ether resin including a polyphenylene ether having a bismaleimide group at molecular ends thereof, a polyphenylene ether having a methacrylate group at molecular ends thereof, a polyphenylene ether having a styrene group at molecular ends thereof, or a combination thereof,” the rubber resin material can have various properties.

Further, in the rubber resin material and the metal substrate provided by the present disclosure, by virtue of “a molecular weight of the liquid rubber ranging from 3,500 g/mol to 4,200 g/mol,” the resin composition can have good flowability.

Further, in the rubber resin material and the metal substrate provided by the present disclosure, by virtue of “a hydroxyl value of the polyphenylene ether resin being lower than 0.5 mg KOH/g,” the rubber resin material can have a strong adhesive force with a metal layer.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A rubber resin material, comprising a resin composition and inorganic fillers, the inorganic fillers being uniformly dispersed in the resin composition, wherein the resin composition includes:
10 wt % to 50 wt % of a liquid rubber;
20 wt % to 60 wt % of a polyphenylene ether resin, wherein the polyphenylene ether resin includes a polyphenylene ether that has a bismaleimide group at molecular ends thereof, a polyphenylene ether that has a methacrylate group at molecular ends thereof, a polyphenylene ether that has a styrene group at molecular ends thereof, or a combination thereof; and
5 wt % to 60 wt % of a cyanate resin, wherein the cyanate resin includes a bisphenol M type cyanate resin.

2. The rubber resin material according to claim 1, wherein a bismaleimide resin is absent from the resin composition.

3. The rubber resin material according to claim 1, wherein a molecular weight of the cyanate resin ranges from 100 g/mol to 3,000 g/mol.

4. The rubber resin material according to claim 1, wherein a number average molecular weight of the polyphenylene ether resin ranges from 1,500 g/mol to 5,000 g/mol.

5. The rubber resin material according to claim 1, wherein a hydroxyl value of the polyphenylene ether resin is lower than 0.5 mgKOH/g.

6. The rubber resin material according to claim 1, wherein a molecular weight of the liquid rubber ranges from 3,500 g/mol to 4,200 g/mol.

7. The rubber resin material according to claim 1, wherein the liquid rubber is synthesized from a butadiene monomer; wherein, based on a total amount of the liquid rubber being 100 wt %, the liquid rubber contains 60 wt % to wt % of a vinyl group.

8. The rubber resin material according to claim 1, wherein the liquid rubber is a butadiene homopolymer.

9. The rubber resin material according to claim 1, wherein a viscosity of the liquid rubber measured at 25° C. ranges from 35,000 cps to 43,000 cps.

10. The rubber resin material according to claim 1, wherein, based on a total weight of the resin composition being 100 phr, an amount of the inorganic fillers ranges from 50 phr to 180 phr.

11. The rubber resin material according to claim 1, wherein the inorganic fillers undergo a surface modification process to have at least one of a methacrylate group and a vinyl group.

12. The rubber resin material according to claim 1, further comprising a peroxide, wherein, based on a total weight of the resin composition being 100 phr, an amount of the peroxide ranges from 0.5 phr to 5 phr.

13. A metal substrate, comprising a substrate layer and a metal layer disposed on the substrate layer, wherein the substrate layer is formed from a rubber resin material, the rubber resin material includes a resin composition and inorganic fillers, the inorganic fillers are uniformly dispersed in the resin composition, and the resin composition includes:
10 wt % to 50 wt % of a liquid rubber;
20 wt % to 60 wt % of a polyphenylene ether resin, wherein the polyphenylene ether resin includes a polyphenylene ether that has a bismaleimide group at molecular ends thereof, a polyphenylene ether that has a methacrylate group at molecular ends thereof, a polyphenylene ether that has a styrene group at molecular ends thereof, or a combination thereof; and
5 wt % to 60 wt % of a cyanate resin, wherein the cyanate resin includes a bisphenol M type cyanate resin.

14. The metal substrate according to claim 13, wherein a dielectric dissipation factor of the rubber resin material measured at 10 GHz is lower than 0.0035.

15. The metal substrate according to claim 13, wherein a dielectric constant of the rubber resin material measured at 10 GHz ranges from 3.0 to 3.5.

16. The metal substrate according to claim 13, wherein a glass transition temperature of the rubber resin material ranges from 210° C. to 270° C.

17. The metal substrate according to claim 13, wherein a peeling strength of the metal substrate ranges from 4.0 lb/in to 7.5 lb/in.

18. The metal substrate according to claim 13, wherein a coefficient of thermal expansion of the metal substrate ranges from 20 ppm/° C.·K to 40 ppm/° C.·K.
